(19) United States
(12) Patent Application Publication
(10) Pub. No.: US 2010/0075291 A1
(43) Pub. Date: Mar. 25, 2010

(54) AUTOMATIC EDUCATIONAL ASSESSMENT SERVICE

(76) Inventors: Dennis C. DeYoung, Webster, NY (US); Charles A. Baxter, Rochester, NY (US); Michael R. Campanelli, Webster, NY (US); Kristine A. German, Webster, NY (US); Steven J. Harrington, Webster, NY (US); Robert M. Lofthus, Webster, NY (US); Raj Minhas, Churchville, NY (US); Gavan Tredoux, Penfield, NY (US); Dennis L. Venable, Marion, NY (US); Peter J. Zehler, Penfield, NY (US)

Correspondence Address: Xerox Corporation (CDFS), 445 Broad Hollow Rd.-Suite 420, Melville, NY, 11747, US

(21) Appl. No.: 12/339,771

(22) Filed: Dec. 19, 2008

Related U.S. Application Data
(63) Continuation-in-part of application No. 12/237,692, filed on Sep. 25, 2008.

(51) Int. Cl. G09B 7/00

(52) U.S. Cl. 434/350; 434/353; 707/603

(57) ABSTRACT

A method and system for automatically helping a teacher/educator evaluate assessments administered to students for determining student's attributes. The teacher/educator reviews stored assessment forms at a digital user interface (DUI) at a multifunction device (MFD) and selects the desired forms and creates an Assessment Batch which includes a List of Students to be given the forms for marking. The system automatically codes each form with personalized student information and prints the individualized assessment forms. The system may include an assessment repository for storing assessment definitions, rubrics, and administered assessments (e.g., results sheets), an may additionally or alternatively include an assessment analyzer for interpreting scanned imaged of administered assessments. The teacher/educator administers the assessment and assessment forms are manually marked, collected and scanned at the MFD, entered into storage and the marked images automatically analyzed and the assessments automatically evaluated from stored rubrics and the teacher/educator is automatically notified by email that the evaluation has been performed. The system enables the teacher/educator to review the evaluations remotely and validate/annotate the evaluation and update the records in storage. The Assessment Batch may be created for a list of students in a group, a class, a grade level, a school, a plurality of schools and students in a geographical area.

### CROSS-REFERENCE TO RELATED APPLICATION

This application is a Continuation-in-Part application which claims the benefit of and priority to U.S. application Ser. No. 12/237,692 filed on Sep. 25, 2008, the entirety of which is hereby incorporated by reference herein for all purposes.

### BACKGROUND

The present disclosure is directed to creating, grading, and analyzing the results of tests, or “assessments”, that are administered to students, and in particular, to a computer-implemented educational assessment system and method for generating and administering student assessments, for evaluating the results thereof to enable educators to identify strengths and weaknesses of students both individually and in the aggregate, and for tailoring the learning experience of students in a classroom more closely to the students' individual needs. The present disclosure relates to the process of assessing the attributes of a student or group of students at selected times during their learning process and relates to the assessment and evaluation of student attributes or progress in a structured classroom where a teacher is required to educate the students to a level of proficiency in various subject matters and at particular grade levels.

Historically, classroom education has a one-to-many structure wherein a lesson is presented by a teacher to a group of students. For example, a typical mid-19^{th} century classroom might include group of students representing a broad range of age and intelligence. Most likely, one might find all the school-age children and teenagers in the community grouped together in a single schoolhouse under the auspices of a single teacher. Accordingly, lesson plans were often broadly focused in order to accommodate the disparate needs of such a varied student populace, which as a result left the educational needs of some students unfulfilled, while leaving other students overwhelmed. This schoolhouse model of education may have been inefficient, since teachers would need to break out lessons into age groups wherein lessons were directed to smaller groups of children of similar age and/or intelligence, leaving the rest of the class to review or self-study.

In later years, school populations increased (due in part to the proliferation of motorized school buses and general population increases) and subsequently, the classroom environment evolved whereby students were grouped and taught by age in separate grade levels in separate classrooms. Such grouping permitted better tailored lesson plans, since the range of educational needs of a group of students of similar age is much less than that seen in the old schoolhouse model. However, while separate grade levels reduced to a certain extent differences in students based on age, they did little to help teachers deal with differences in student based on intellect. Hence it was still possible for students with substantially differing cognitive abilities to be grouped in the same classroom. Additionally, since underperforming students were occasionally “left back” (e.g., made to remain in a grade level rather than be promoted with his or her peers to the next level) it was still possible for younger, more capable students to be grouped with older, underperforming students.

Various strategies for identifying and adapting to the individual needs of students have been tried. Such techniques have included grouping students in smaller groups (e.g., decreasing the student-to-teacher ratio), grouping students according to age and ability (e.g., placing advanced students in so-called “honors” classes and vice versa), and the use of computerized teacher gradebooks (e.g., student information systems or SIS). However, such efforts have met with limited success, largely because of a teacher's limited capacity to perform the necessary analytical and logistical work required to offer lesson plans and activities that precisely meet the needs of each individual student. The barriers of time and limited resources often limit even the most dedicated teachers to forming subgroups within a classroom in an attempt to address the needs of each group. Moreover, such groups cannot be readily evaluated nor changed frequently due to logistical overhead involved therein, and creating a lesson plan for a number of small groups can be much more work than creating one for the entire class. Having the ability to create individualized lesson plans for each student (or even small, dynamic groups of students) and the ability to assess each student's performance on an individualized basis would be a welcome advance in the educational arts.

Multi-function devices, or MFDs, have become familiar in offices and in home computing environments. Whereas, previously, functions such as copying, printing, and facsimile transmission have been performed by single dedicated copiers, printers, and facsimiles respectively, an MFD is typically capable of providing all such functions and more in a single machine. Typically, such an MFD includes a single print engine, which can serve to output copies, print jobs, or received facsimiles; as well as a single input scanner which can serve to record data from original images for use in copying, facsimile transmission, and retention of input image data to a predetermined location in a computer memory (“scan-to-file”) in the MFD or in another device.

Such MFDs are typically connected to data networks, such as a local area network or the Internet, for exchange of both image data and associated metadata. An MFD's connection to a data network also enables an operator to scan a document, creating an electronic image file therefrom, and transmitting the electronic image file to a networked device for storage or processing. The MFD can be a xerographic machine which uses xerographic printing techniques to print a reproduction of a document placed on a platen glass or on an automated document feeder. The MFD can also be a personal computer connected to a page scanner and optionally, connected to at least one of a printer or a communication network.

Typically, in a grade level classroom, e.g., K-12, the teacher periodically gives the students printed test forms, or, as they are now called, “assessments,” in order to obtain an indication of the student(s) level(s) of proficiency in the subject matter of immediate interest.

Heretofore, where a teacher was responsible for a class having a relatively large number of students, the teacher typically passed out to all students a common assessment form. The assessments are distributed to the students who then mark their responses on the forms which are then gathered by the teacher and individually reviewed and evaluated or graded by the teacher.

The process has required the teacher to then manually enter an overall metric of each student's performance on the assessment into a record book or computer data base. Typically the metric is a single total score or percentage of possible points. This process has thus been time consuming and often requires the teacher to spend considerable time outside of the classroom performing these functions. Furthermore, no detailed record is kept regarding how each student performed on each item within the assessment. Given the low resolution metric recorded for each assessment, the recorded results do not fully or meaningfully determine the state of learning of individual students who may be experiencing learning difficulties or are insufficiently prepared for particular elements of the assessment. For example, all students whose total score is 60/100 on an assessment are most likely not making the same incorrect or correct answers, but it is not possible to differentiate their performance if only total scores are recorded

Thus, it has been desired to provide a way or means of automatically scoring and recording detailed assessment results for students in a relatively large class, thereby eliminating the need for manually scoring and entering the results of the evaluations in a record book or database, and eliminating the loss of critical data inherent in the practice of recording only total scores or percentages.

Heretofore, one type of known assessment employed by a teacher for enabling a teacher/educator to evaluate the ability of a student to name a printed letter, is illustrated in FIGS. 21-22 wherein the student is asked to read a letter from a prepared form containing various letters of the alphabet as seen in FIG. 22; and, as the student reads the letters, the teacher manually marks on a separate form, as seen in FIG. 21, the student's response. In the example shown in FIG. 21, the teacher makes a manual mark (shown as a “/”) in one of the columns headed “CC” for correct, “IR” for incorrect response, and “H” if the child hesitates before identifying the letter. Provision is made at the bottom of the teacher's form for entering comments or notes. The teacher must then interpret and transcribe the results of the markings on the assessment of FIG. 21 into a data base or grade book in order to have a record of the student's state of learning or progress at that time with respect to the particular subject matter.

FIGS. 19 and 20 illustrate an example of prior art assessments employed for determining the state of learning/knowledge of a student with respect to arithmetic in which the student is required to perform a mathematical addition exercise in a workbook, as seen in FIG. 19, and then to fill-in the corresponding bubble in the accompanying answer sheet, as seen in FIG. 20. This fill-in-the bubble assessment form is amenable to machine scoring but is not suitable for young students. Additionally, many assessments cannot be presented in a fill-in-the-bubble format.

### BRIEF DESCRIPTION

The present disclosure describes a system for automatically evaluating assessments of the type given by a teacher/educator for determining the state of learning or progress of students during the course of instructions; and, the system is applicable particularly in a classroom setting where the teacher is responsible for educating a relatively large group of students. The system and technique of the present disclosure enables the teacher/educator to select from the digital user interface (DUI) of a Multifunction Device (MFD) any of multiple predetermined stored assessment forms in a Data Warehouse/Repository of such assessment forms for administration to a teacher/educator selected group of one or more students.

The teacher then requests the system to create an Assessment Batch and to print out personalized versions of the assessment form, where each version is automatically bar coded for the individual student. The student's name is also printed on the form for the purpose of delivering each assessment to the appropriate student. If desired, the student's name may be printed on the reverse side of the form such as, for example in large print, such that the person administering the test can verify from a distance that each student has the correct form, and so that forms can be handed out individually without disclosing the content of the assessment.

Once the students have completed the assessment, or alternatively where the teacher/educator marks the assessment in accordance with the students' oral responses, the marked assessment forms are then scanned into the system at the MFD.

Based on the information bar coded on the scanned forms, the system then identifies the student and Assessment Batch. The system then employs the appropriate image analysis of the markings, and performs an evaluation of each item on each of the assessments based upon a pre-programmed rubric. In embodiments, a rubric may be an answer key in which correct answers and associated metadata, such as without limitation free form or handwritten answer marks, are specified. The system then automatically stores a preliminary evaluation in the Data Warehouse/Repository for each student. The teacher/educator may then view the assessments at a remote terminal and validate/annotate them. The system then automatically updates the validated/annotated assessment records in the Data Warehouse/Repository (DWIR) for later retrieval in various report views, which may be retrieved at the MFD or remotely by the teacher or other authorized educator.

In embodiments according the present disclosure, an assessment-enabled multi function device (AE-MFD) includes an assessment module for communicating with at least one of the DUI of the MFD and an assessment service provider, which may be without limitation provide an assessment analysis service, an assessment repository service, and/or a data warehouse repository service. In embodiments, the assessment module may be in operable communication with a student information system (SIS). An assessment service provider may include at least one of an analysis module for interpreting scored assessments and an assessment generation module for creating, storing, and generating (i.e., printing) assessments.

In another embodiment, a computer-assisted method for educational assessment is disclosed wherein an MFD is provided. The MFD may include a processor configured to receiving an assessment definition from a user. An assessment definition may include choosing among predetermined or previously-written assessments, or a defining an assessment ab initio. An assessment repository device, which may include a processor configured to execute a programmable set of instructions, e.g., a software module, for generating an assessment form in response to an assessment definition. For example without limitation, delivery of a previously-created assessment form (i.e., an assessment definition) that is stored within the assessment repository device may be requested by the MFD from the assessment repository device. In response, the assessment repository device transmits the requested assessment form to the MFD. In embodiments, at least one assessment form is delivered for each student in a given class, thereby providing to the teacher/educator a complete set of assessment for administering to the class.

In embodiments, a method performing educational assessment in accordance with the present disclosure includes storing educational assessment definitions in an assessment repository device, such as without limitation, a server, a hardware device, a software module or a combination thereof. For each student in an assessment group (e.g., a class), an educational assessment form may be generated from one of the educational assessment definitions. An educational assessment form corresponding to the educational assessment and uniquely corresponding to each individual student may be printed using, for example without limitation, a multi-function document processing device. In this manner, an individual form is printed for each student, which may contain the student's name, teacher's name, classroom identifier, date, assessment identifier, or any other suitable identifier.

After administering the assessment form(s) by, e.g., recording student responses thereupon by handwritten marks, the forms are scanned at, for example without limitation, the multi-function document processing device. In embodiments, the administered assessment forms may be scanned by any suitable scanner, such as without limitation a desktop scanner, page scanner, or fax machine.

Educational assessment data is generated from the scanned assessments and stored on an assessment repository device which may be, without limitation, a server, a hardware device, a software module or a combination thereof. The assessment data is then evaluated to optimize a lesson plan.

An educational assessment system contemplated by the present disclosure may include a multi-function document processing device, which may have a processor and a memory. The educational assessment system may include an educational assessment repository module in operable communication with the multi-function document processing device and capable of storing at educational assessment documents and educational assessment data corresponding thereto.

The educational assessment system may include an educational assessment analysis module communicating with the multi-function document processing device and/or the educational assessment repository module. The educational assessment analysis module may be configured to use an unadministered educational assessment document and an administered educational assessment document, which may be stored in the assessment repository module, to establish or generate educational assessment data corresponding to the administered educational assessment. For example without limitation, the educational assessment analysis module may compare a “clean” assessment document (or data representative thereof) with no answer responses written thereupon to a “filled out” assessment document (or data representative thereof.) The resuling educational assessment data, which may be a score, may then be transmitted to the educational assessment repository module.

In yet another embodiment, an assessment evaluation device, which may include a processor configured to execute a programmable set of instructions for receiving data corresponding to a completed assessment form and converting the received data into at least one assessment score, is provided wherein scans of completed assessments are transmitted thereto for scoring. The assessment evaluation device may compare each completed assessment to a corresponding rubric for evaluating the completed assessment and ascertaining the assessment score. In embodiments, a rubric may contain metadata for identifying correct and/or incorrect answers, and may include metadata for evaluating and interpreting free form (e.g., handwritten) marks and/or comment. Examples of free form marks include without limitation a mark indicating whether a student hesitated before answering, a mark indicating the student's confidence level, a mark indicating whether the student gave the correct pronunciation, and the like.

In accordance with the present disclosure, a scanning device, which may include a processor, may be provided for scanning an administered assessment page into digital form for, e.g., evaluation, archiving, printing, and/or displaying. The scanning device may be included in the provided MFD.

An assessment definition may be received at the MFD, whereupon the MFD generates (i.e., prints) the assessment for subsequent administration to a student. In embodiments, the assessment may uniquely corresponds to an individual student, for example without limitation, may include the student's name and/or an identification code therefor, any of which may be presented in human readable (e.g., textual) and/or machine-readable (e.g., barcode) form. Advantageously, the assessments may be printed in a batch mode wherein all of the assessment for a predetermined class of students are printed in one batch print job. Once printed, the assessments are administered to the student(s). Upon completion of the administration, the completed assessments are scanned at the scanning device (e.g., the MFD or a standalone scanning device), and transmitted to the assessment evaluation device. The assessment evaluation device analyzes the scanned assessment(s) in view of the corresponding rubric, and establishes the assessment score. The scanned assessment(s), score(s) thereof, and associated metadata may then be stored, e.g., at the assessment repository device.

In an envisioned embodiment, an assessment-enabled multi-function device (AE-MFD) of the type having the capability of scanning, copying and electronically transmitting documents is provided. The AE-MFD may include in operable communication a scanning assembly, a printing assembly (e.g., a xerographic printing engine assembly), a user interface (e.g., an LCD touch screen and/or pushbuttons), a data communication interface (e.g., an 100base-T Ethernet interface, 802.11 “WiFi” interface, and the like), and a processor, The AE-MFD also includes an assessment module configured to communicate with at least one of an assessment repository device and an assessment analysis device. The assessment module is further configured to accept a user input specifying an assessment, dispatch an assessment generation request to the assessment repository device, receive an assessment form, and printing the assessment form on the print assembly.

In yet another envisioned embodiment, an assessment repository device is provided which includes in operable communication a processor, a storage module (e.g., semiconductor and/or disk-based data storage device), a data communication interface are previously described herein, and an assessment repository module. The assessment repository module is configured to communicate with at least one of an AE-MFD and/or an assessment analysis device. The assessment repository module is further configured to receive an assessment request and to respond to the assessment request by transmitting, or causing to be transmitted, at least one corresponding assessment form.

In still another envisioned embodiment, an assessment analysis device is provided. The assessment analysis device may include in operable communication a processor, a storage module as previously described herein, a data communication interface as previously described herein, and an assessment analysis module. The assessment analysis module may be in operable communication with at least one of an assessment-enabled multi function device and an assessment repository device. The assessment analysis module may further be configured to receive an assessment analysis request and in response, transmit a corresponding assessment batch request to receive an assessment batch which includes at least one completed assessment. In embodiments, an assessment analysis request may be combined with a corresponding assessment batch. The assessment analysis module may then apply a rubric to the at least one received completed assessment to generate an assessment score. An assessment score storage request may be transmitted by the assessment analysis module to store the generated assessment score. In embodiments, the assessment score storage request may be transmitted to an assessment repository device (e.g., a data warehouse).

In another envisioned embodiment, an assessment verification device is disclosed for enabling a teacher/educator to access, view, modify, transmit, receive, and delete at least one assessment(s) and/or metadata associated therewith. The assessment verification device includes a processor in operable communication with an assessment access module that is configured to perform the desired operation, e.g., displaying, modifying, transmitting, receiving, and/or deleting at least one assessment and/or the associated metadata.

In embodiments, the generated educational assessment data may be verified against the corresponding administered assessment form to determine whether a discrepancy exists between the handwritten marks and the generated educational assessment data. If discrepancies are identified, such discrepancies may be corrected/addressed by modifying the assessment data and/or the educational assessment definition.

### BRIEF DESCRIPTION OF THE DRAWINGS

FIG. 1 is a pictorial diagram of the method flow of the present disclosure;

FIG. 2 is a diagram of the general configuration of the system architecture of the present disclosure;

FIG. 3 is a flow diagram of the initial portions of the process of the present disclosure for Assessment Batch formation, printing and manual marking;

FIG. 4A is a similar flow diagram of a continuation of the process from FIG. 3 for the scanning of assessments and the determination of the status of the scanned Assessment Batch(es);

FIG. 4B is a continuation of FIG. 4A and includes the option of updating any Batch Preliminary Evaluation status from Pending to Ready;

FIG. 5 is a continuation of the process of FIG. 4B including the automatic lifting of markings and automatic evaluation of the assessment items;

FIG. 6 is a continuation of the process of FIG. 5 including teacher correction, annotation and validation;

FIG. 7 is a continuation of the process of FIG. 6 including generation of reports;

FIG. 8 is an example of an assessment for determining a student's state of learning or ability with respect to letter and word sounds and is of the type requiring image analysis for evaluation;

FIG. 9 is an example assessment items for determining a student's ability to scribe arithmetic numerals and requiring image analysis for evaluation;

FIG. 10 is an assessment item for determining the student's skills in performing a mathematical operation and requiring image analysis for evaluation;

FIG. 11 is another example of assessment items for determining student's capability in counting and numeral writing readiness for mathematics instruction and requiring image analysis for evaluation;

FIG. 12 is another example of an assessment item wherein the student must draw a line to the correct election of symbols and requiring image analysis for evaluation;

FIG. 13 is another example of assessment items wherein the student is required to encircle the correct symbol requiring image analysis for evaluation;

FIG. 14 is another completed example of an assessment requiring the student to encircle more than one set of symbols and requiring image analysis for evaluation;

FIG. 15 is another example of the type of assessment item shown in FIG. 13 prior to marking by the student and requiring image analysis for evaluation;

FIG. 16 is an example of an assessment wherein the student must recognize the commonality of the name of the illustrated object and the letter and requires image analysis for evaluation;

FIG. 17 presents another exemplary assessment employed to in the present disclosure to determine the student's capability to manually reproduce a picture and requires image analysis for evaluation;

FIG. 18 is another example of an assessment wherein the student must choose and circle images based upon the student's recognition of the object and understanding of the question asked relating to the images and requires image analysis for evaluation;

FIG. 19 is an example excerpt from of a prior art assessment relating to a workbook for a multiple choice fill-in-the-bubble format exam;

FIG. 20 is an example excerpt from of a prior art assessment fill-in-the-bubble answer sheet corresponding to the workbook in FIG. 19;

FIG. 21, excerpted from “The Abecedarian Reading Assessment” by Sebastian Wren and Jennifer Watts, is an example of an assessor completed and marked prior art assessment;

FIG. 22, excerpted from “The Abecedarian Reading Assessment” by Sebastian Wren and Jennifer Watts, is a student hand-out sheet for use administering the assessment of FIG. 21;

FIG. 23 is an exemplary assessment item for use with the present method of the type for determining student preferences and requires image analysis for evaluation;

FIG. 24 is an exemplary assessment item of the type for determining a student's area of interest and requires image analysis for evaluation;

FIG. 25 is a block diagram of an embodiment of an educational assessment system in accordance with the present disclosure;

FIG. 26 is a block diagram of an embodiment of an assessment repository device in accordance with the present disclosure;

FIG. 27 is a block diagram of an embodiment of an assessment-enabled multi function device in accordance with the present disclosure;

FIG. 28 is a block diagram of an embodiment of an assessment analysis device in accordance with the present disclosure;

FIG. 29A is a block diagram of another embodiment of an assessment-enabled multi function device in accordance with the present disclosure;

FIG. 29B is a block diagram of yet another embodiment of an assessment-enabled multi function device in accordance with the present disclosure;

FIG. 30 is a data flow diagram of an embodiment of an automated assessment system in accordance with the present disclosure; and

FIG. 31 is a flow diagram of an automated assessment system in accordance with the present disclosure.

### DETAILED DESCRIPTION

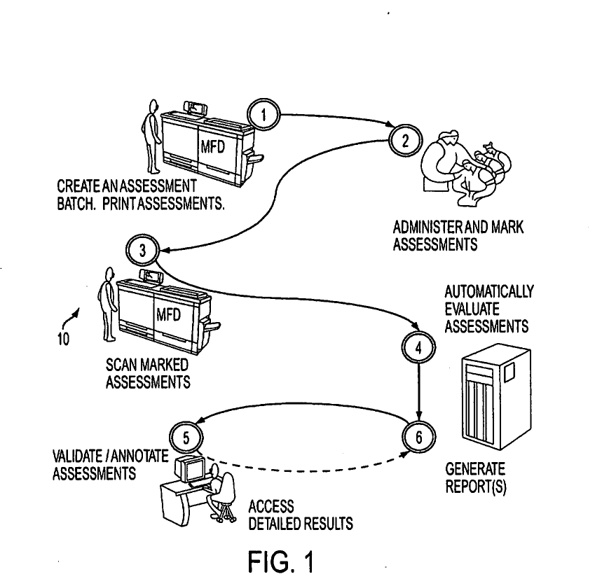

Referring to FIG. 1, an overview of the functional operation of the method of the present disclosure is illustrated wherein at station 1 the multifunctional device (MFD) is provided for the teacher/educator to input the information required regarding the assessment form and student or number of students desired to create an Assessment Batch; and, once the Assessment Batch has been created in the system by teacher/educator input at the DUI (digital user interface) of the MFD, the assessments may be also printed at the MFD or any remote printer connected thereto. In the present practice, an Assessment Batch includes the teacher's name and a student list which includes the names of the students to be included in the batch, the particular assessment form to be administered to the students in the student list and the creation date of the Assessment Batch.

At station 2 of the system indicated generally at 10 in FIG. 1, the teacher/educator administers the assessments which are marked. Depending on type of the assessment, the printed sheets may be marked by the teacher/educator or the students according to the nature of the assessment.

At station 3, the teacher/educator or their designated representative, scans the marked assessments into the system at the MFD. At station 4, the system automatically evaluates the assessments employing image analysis according to the established rubrics associated with the assessment form associated with the Assessment Batch and enables the teacher to access the evaluations at station 5 which is illustrated as a remote station such as a teacher's personal computer (PC). The teacher/educator validates/annotates the assessments and upon receipt of the validation, the system generates reports at station 6 which may be accessed and viewed at either the MFD or the teacher's personal computer terminal remote from the MFD.

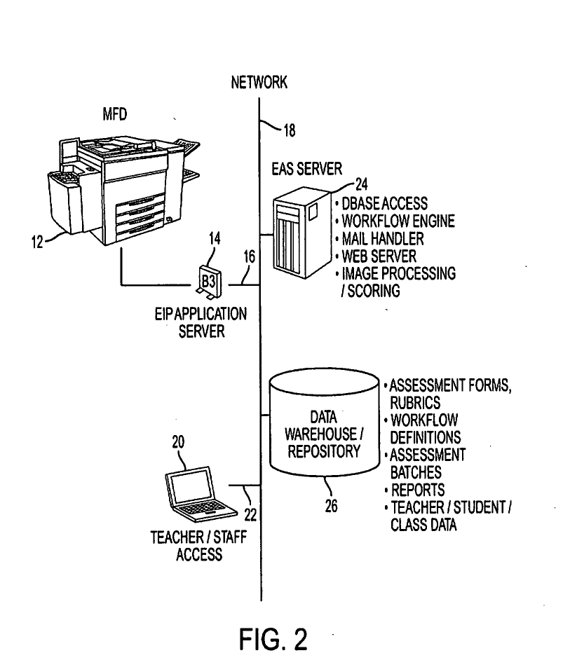

Referring to FIG. 2, the overall architecture of the system employed with the present method is illustrated pictorially with the MFD 12 connected through an application server 14 along line 16 to a network 18 which may be either a local or wide area network and may include connections to the internet. A remote terminal or PC 20 such as a teacher/educator access terminal is connected along line 22 to the network 18. A system server 24 is also connected to the network 18 and provides the functions of database access, serves as a workflow engine, mail handler, web server and functions of image processing/scoring.

A Data Warehouse/Repository 26 is also connected to the network and contains such items as assessment forms and associated rubrics, workflow definitions, Assessment Batch records, reports and teacher/student/class data and is operable to receive updates and to provide for access to data stored therein remotely therefrom over network 18.

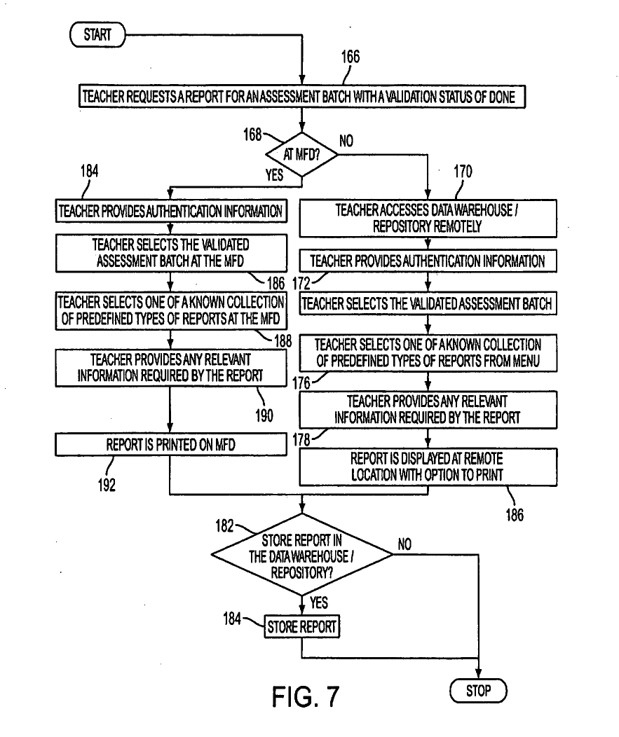

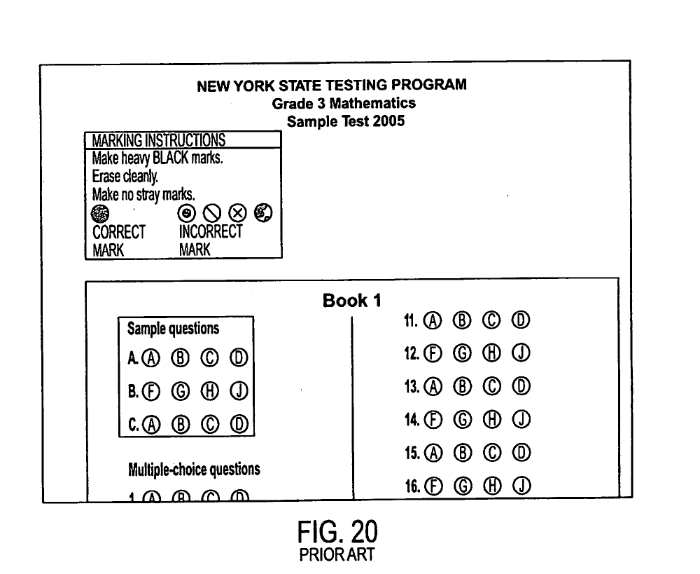

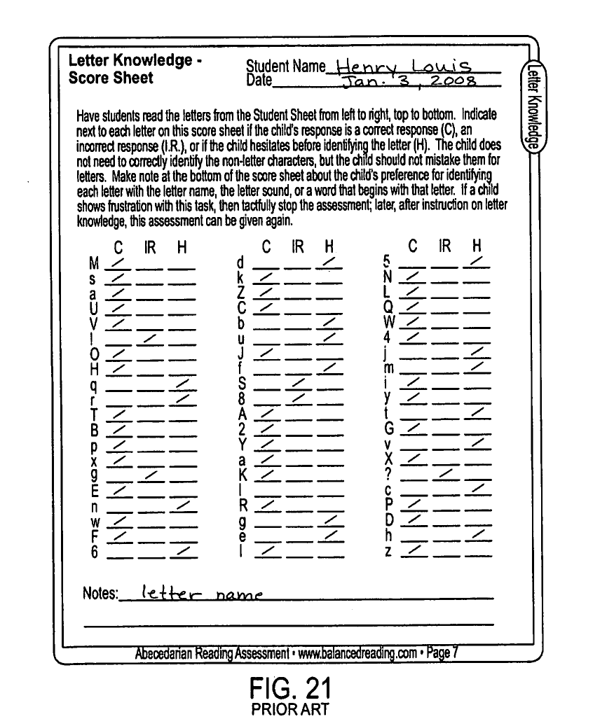

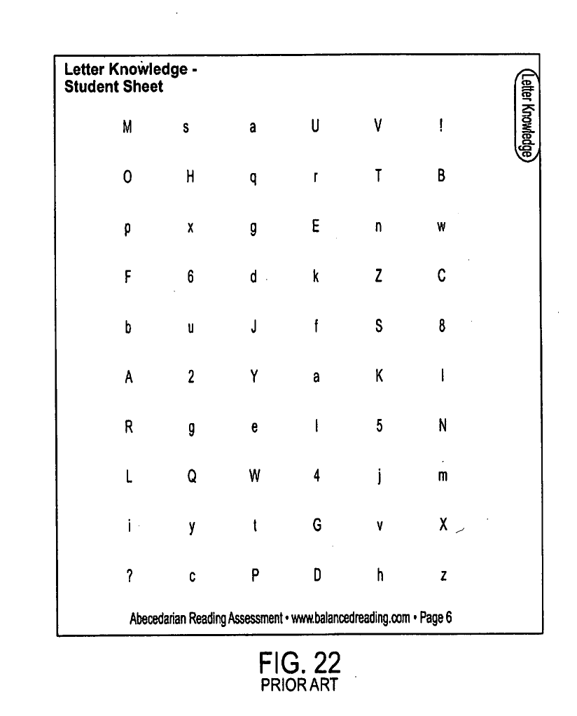

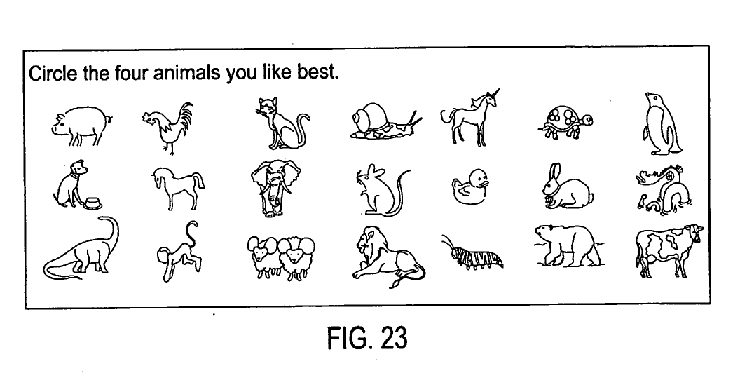

As mentioned hereinabove, the system and method of the present disclosure function to assist a teacher/educator by providing automatic evaluation of assessments administered to students based upon established rubrics programmed into the system and employing image analysis. The system and method of the present disclosure have the capability to evaluate assessments which are marked with images other than by marking within a box or bubble with respect to multiple choice answers. The system has the ability to scan the marked assessment and lift the manually made marks made during the administering of the assessment from the preprinted markings on the assessment sheet. The system and method then employ image analysis to identify and evaluate the lifted marks. The method and system are capable of handling numerous types of assessment items employed by teachers/educators examples of which are illustrated in the present disclosure in FIGS. 8-22.

Various types of assessments may be administered to the students and may include summative, formative, diagnostic, interest, preference and benchmark assessments.

Referring to FIG. 8, an assessment is illustrated wherein the teacher/educator or person administering the assessment orally recites sounds associated with letters of the alphabet and the student is challenged in section one to identify the letter associated with the pronounced sound and to scribe the letter onto the assessment sheet. In section 2 of FIG. 8, the teacher/educator or person administering the assessment recites a word and the student is challenged to write or print the word that was pronounced. In item 4 of section 2 of FIG. 8, the word “sack” has been pronounced by the teacher. The system by virtue of image analysis can identify alternatives that the student would print in recognition such as, for example phonetic spellings “sak” or “sac” for which the student would be given credit for correctly identifying the phoneme. In item 5 of section 2 of FIG. 8, the work “crib” has been pronounced; and, the student in recognizing the word associated with the pronunciation may write the word “krib” as phonetically spelling what the student heard, in which case the student would be given credit for correctly recognizing the word albeit incorrectly spelling the word. The system of the present disclosure by virtue of image analysis would be capable of identifying the spelling “krib” as a phonetic spelling of the pronounced word.

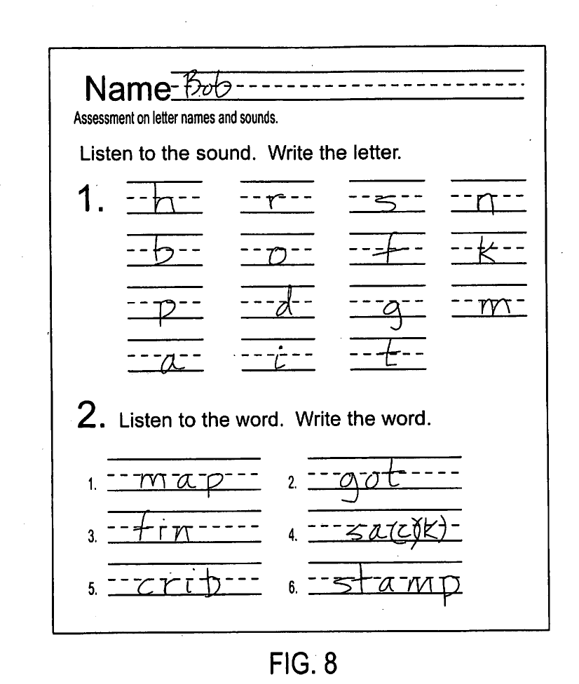

Referring to FIG. 9, additional assessment items are illustrated in which the student is challenged to replicate by hand the shape of a number within a defined space and the system is then required to recognize and identify the drawing by the student as to its similarity to the number by image analysis.

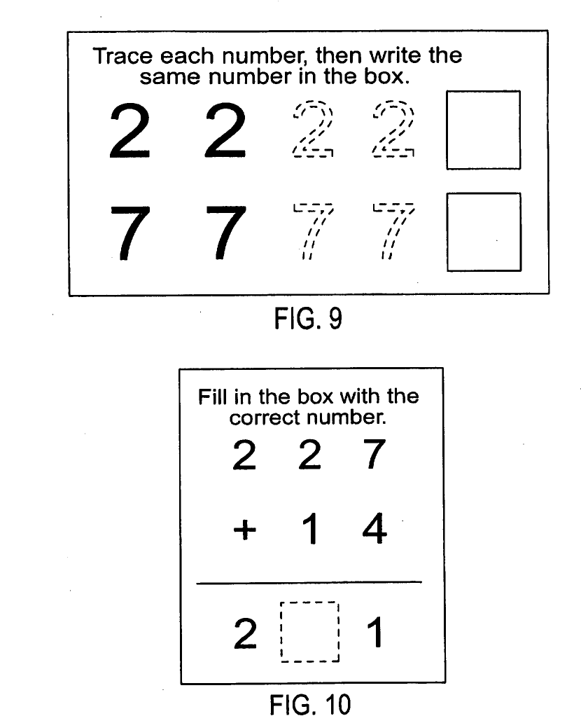

FIG. 10 illustrates an assessment item of the type requiring the student to perform a mathematical operation, such as addition, and to write the correct numeric answer in the appropriate digit space provided as blank. Thus, the system employing the method of the present disclosure operates to recognize the image created by the student of the numerical answer in order to provide an automatic evaluation of the assessment item.

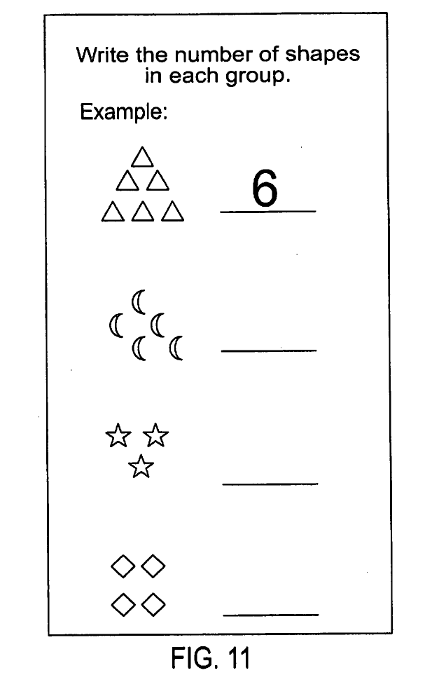

Referring to FIG. 11, exemplary assessment items are illustrated wherein the student is challenged to recognize the number of shapes presented in the drawing and to write or scribe the correct numeral associated with the shape count. The system of the present disclosure then determines by image analysis whether the marking by the student is the correct numeral for the problem.

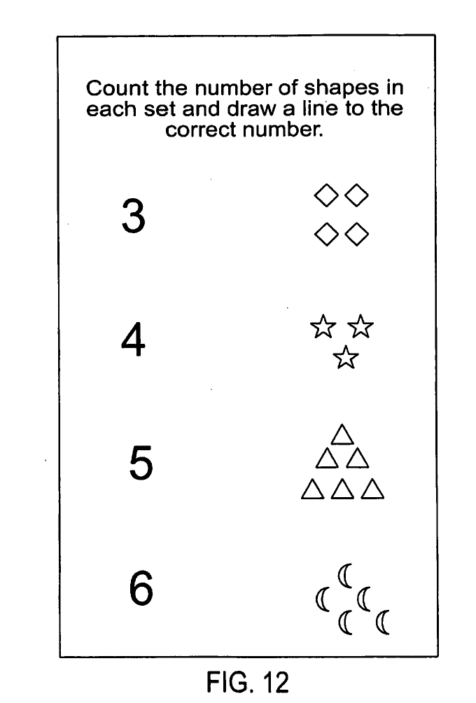

Referring to FIG. 12, is another exemplary assessment item wherein groups of images of specific shapes are presented and the student is required to draw a line from the group of shapes to the correct numeral representing the count of the number of shapes in the picture. The system employed in the method of the present disclosure thus by image analysis identifies the direction and connection of the line drawn by the student in performing the automatic evaluation of the assessment item.

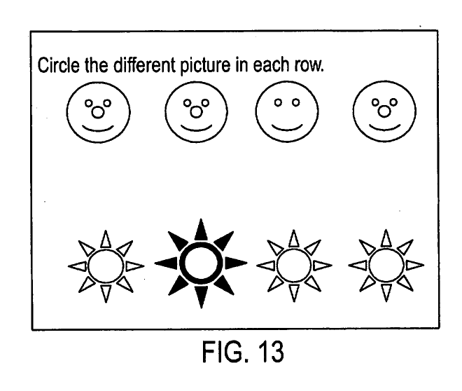

Referring to FIG. 13, additional exemplary assessment items are illustrated in which rows of pictures are presented and the student is challenged to mark, typically by encircling, the picture among the row which is dissimilar to the remaining pictures. The system then by image analysis identifies the location of the marking and makes a determination as to whether the correct picture has been marked and automatically performs the evaluation of the assessment items.

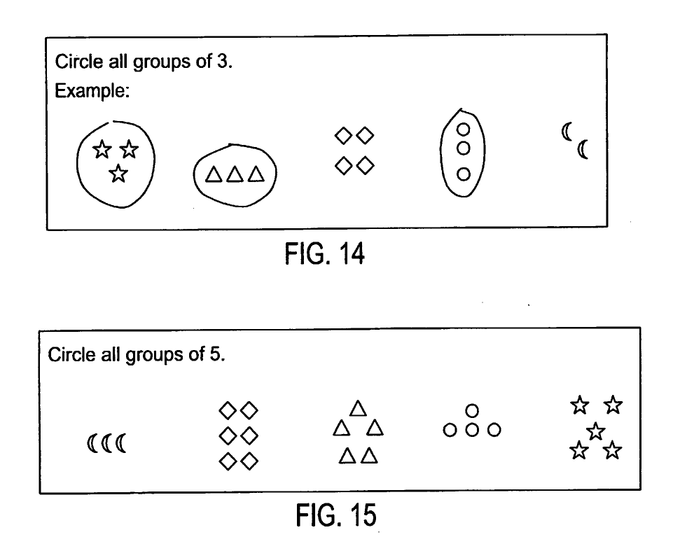

Referring to FIG. 14, an exemplary assessment item is illustrated which has been correctly marked to show a student the manner in which the assessment item is to be performed; and, the assessment item of FIG. 14 requires the student to mark more than one, and in the illustrated case, 3 groups of pictures containing a numerically specified group of images. The system then by image analysis, determines if the correct groups of pictures have been marked by the student.

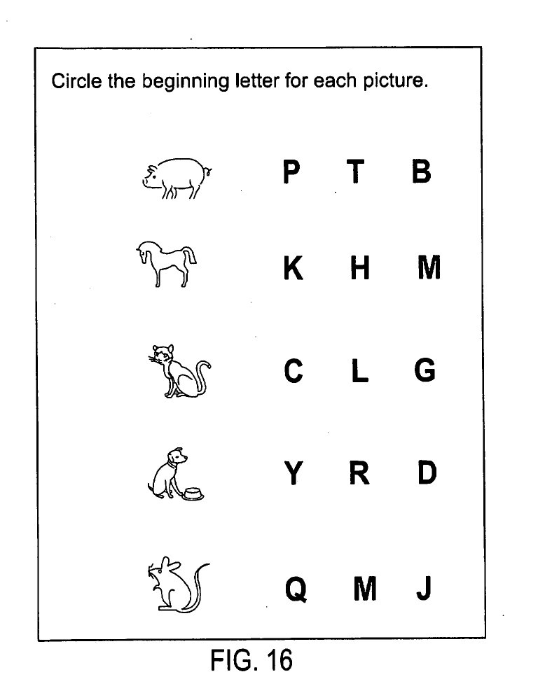

FIG. 15 illustrates another exemplary assessment item of the type described in FIG. 14 and the form in which it is presented to the student for administering the assessment item.

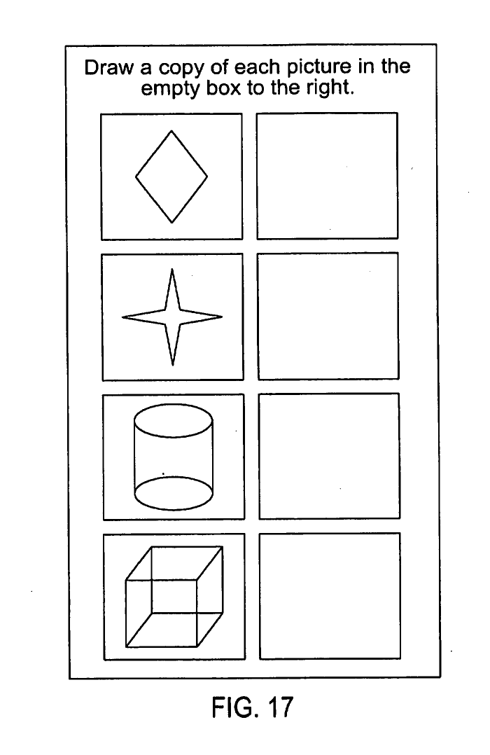

Referring to FIG. 16, in another exemplary embodiment of assessment items is illustrated in which a group of images, such as animals, are presented, each associated with a row of letters of the alphabet and requires the student to identify the word name of the animal in the picture and to mark the appropriate letter for the beginning of the animal name. Thus, the system by image analysis determines which letter in each row has been marked and automatically performs the evaluation of the assessment items.

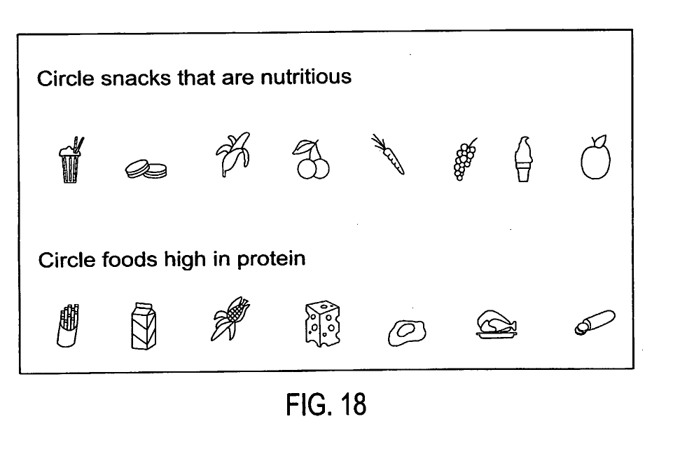

Referring to FIG. 17, additional exemplary assessment items are shown wherein line pictures are presented and the student is challenged to manually reproduce each picture. Thus, the system by image analysis determines the degree to which the markings by the student reproduce the pictures in automatically forming an evaluation of the assessment items.

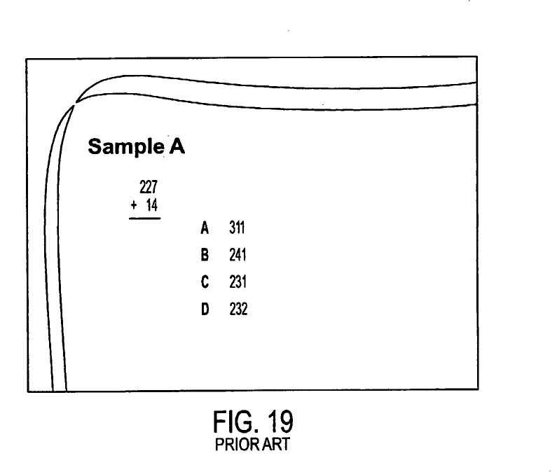

FIG. 18 illustrates another exemplary set of assessment items in which rows of objects are presented and the student is challenged to mark, typically by encircling, the objects in a given row which are representative of a particularly specified characteristic thereby requiring the student to understand the meaning of the described characteristic and employ the described characteristic as a criteria for judging each of the illustrated objects with respect to the specified criteria. The system then by image analysis determines whether the student marking has been made of the correct object(s) and automatically evaluates the assessment items.

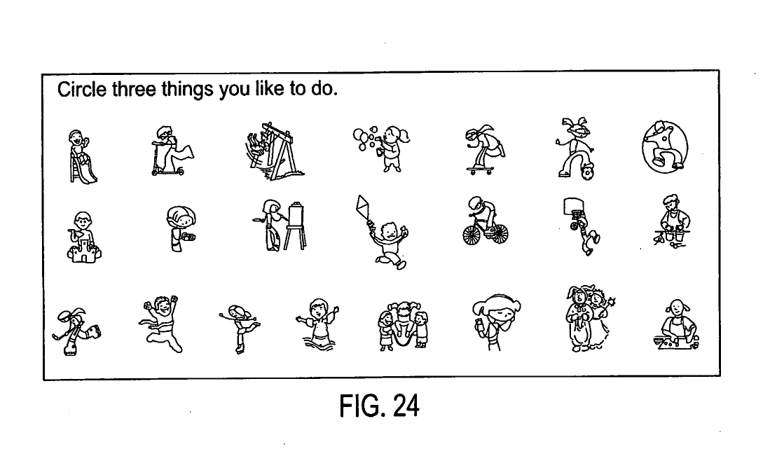

Referring to FIG. 23, an exemplary assessment item is illustrated in which rows of pictures of various creatures are shown and the student is asked to mark, typically by encircling, a specified number of the pictures representative of those creatures for which the student has an association or favors. The system then by image analysis determines which of the pictures has been marked and automatically evaluates the student's preferences from the markings.

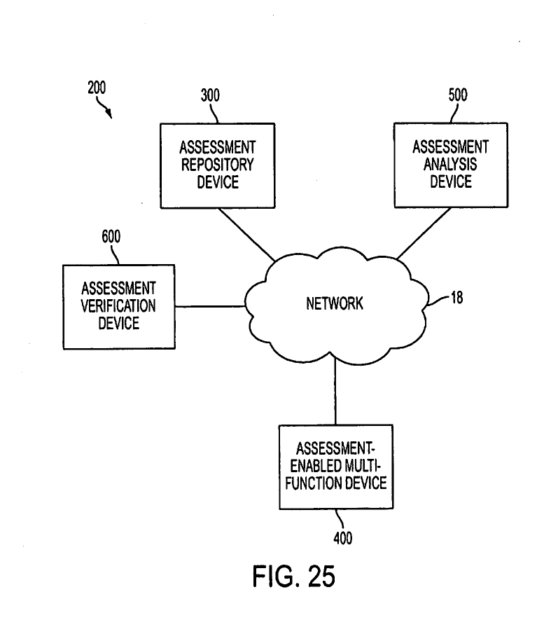

Referring to FIG. 24, another exemplary item is illustrated in which rows of pictures of persons engaged in various activities are presented and the student is asked to mark a specified number of these activities pictorially represented. The system then by image analysis identifies the pictures marked by the student and automatically performs an evaluation to determine the student's areas of interest.

The assessment items described in FIGS. 8-16 can be utilized for either summative or formative type assessments; whereas, FIG. 23 describes a preference type assessment and FIG. 24 describes an interest type assessment.

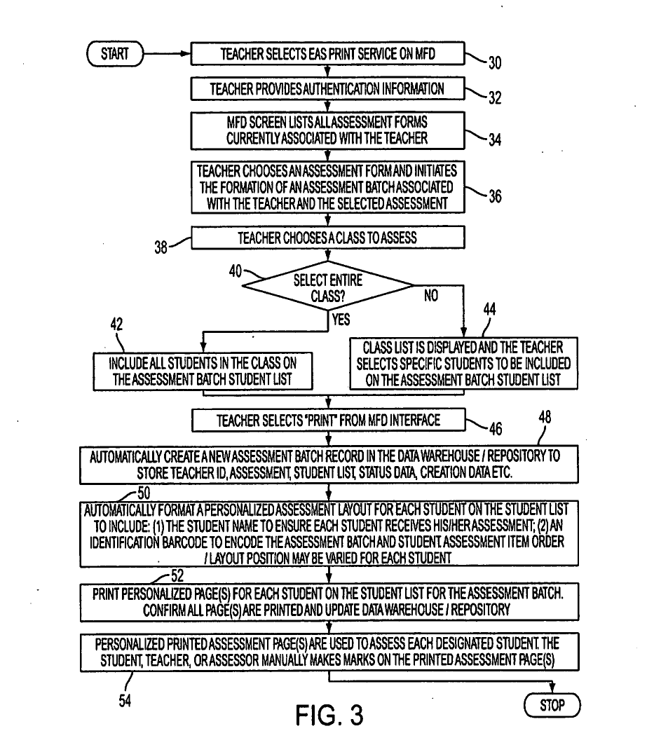

Referring to FIG. 3, the operation of the method of the present disclosure presented in block diagram in which, at step 30 the teacher/educator selects the education assessment service (EAS) print service from the DUI (Digital User Interface) of the MFD 12 and proceeds to require the teacher to provide authentication or personal identification information at step 32. The authentication or personal identification information is compared to stored authentication or personal identification information to confirm the teacher/educator is authorized to access the EAS print service. In embodiments, the authentication or personal identification information is stored in an authentication database. At step 34 the system then proceeds to display on the MFD DUI all the pre-defined assessment forms currently associated with the teacher's identification entered in at step 32.

The teacher then chooses at step 36 an assessment form and initiates the formation of an assessment “Batch” associated with that teacher and the selected assessment form. It will be understood, that once initiated, the “Assessment Batch” comprises the basic evaluation unit or cell that the teacher has requested. The teacher then proceeds at step 38 to input a class to assess such as, for example, a seventh grade class, a seventh grade math class, a fifth grade English writing class, or a fourth grade reading class, etc. The system then proceeds to step 40 and enquires as to whether the teacher/educator wishes to select the entire class; and, if the enquiry in step 40 is answered in the affirmative, the system then proceeds to step 42 and includes all students in the class on the Assessment Batch Student List. However, if the query at step 40 is answered in the negative, the system proceeds to step 44 and the class list is displayed on the MFD DUI and the teacher selects specific students to be included on the Assessment Batch Student List.

From step 42 or step 44 the system then proceeds to step 46 and the teacher is prompted to select print from the MFD DUI. The system then proceeds to step 48 and automatically creates a new Assessment Batch record in the Data Warehouse/Repository to store the teacher's identification, the particular assessment form, the Student List, the status data, the date created, and other data which may be required by the particular school administrator/system.

The system then proceeds to step 50 and automatically formats a personalized assessment layout for each student on the Student List, which layout includes the student name to insure each student receives the correct assessment and an identification bar code to encode the Assessment Batch and the student. The assessment item order/layout for each student may be varied for each student to discourage students from looking at neighboring students' assessments for hints. The system then proceeds to step 52, prints the personalized page(s) for each student on the Student List for the Assessment Batch. The system then confirms that all page(s) are printed and updates the Data Warehouse/Repository.

At step 54, the teacher/educator takes the personalized printed assessment age(s) and administers the assessment to each designated student. The teacher/assessor or student, as the case may be, manually marks on the printed assessment page(s) the appropriate response to the challenge indicated on the particular assessment page. Upon completion of marking of the assessments, the marked assessment pages are collected by the teacher/educator for subsequent evaluation.

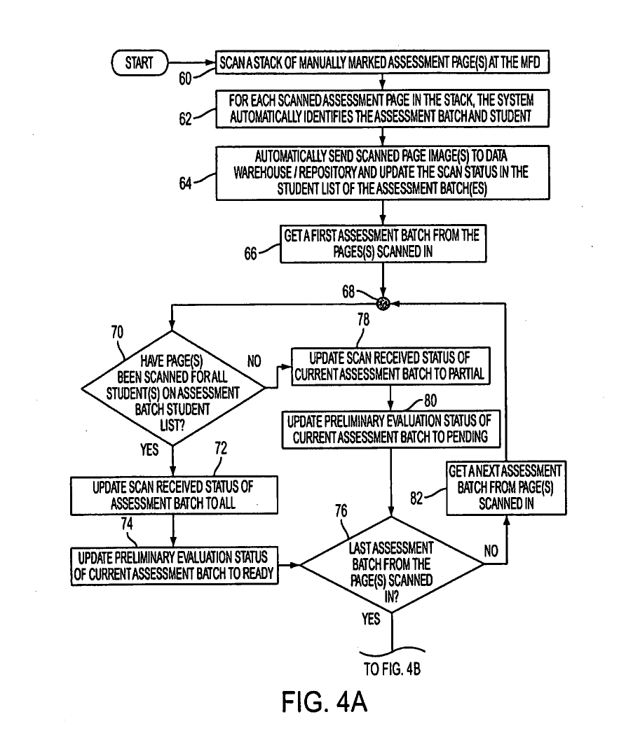

Referring to FIG. 4A, the evaluation phase of the present method is begun wherein at step 60, the teacher/educator scans a stack of manually marked assessment pages at the MFD. At this point there may be assessment pages from multiple Assessment Batches in the stack of sheets scanned in. The system then proceeds to step 62 under the operation of the requested EAS program/function as identified in the barcode found on each assessment page; and, for each scanned assessment page in the stack, the system automatically identifies the Assessment Batch and the student. The system then proceeds to step 64 and automatically sends the scanned page image(s) to the Data Warehouse/Repository and updates the scan status in the Student List of the Assessment Batch(es). The system then proceeds to step 66 and proceeds to get the first or initial Assessment Batch from the page(s) scanned in.

The system then proceeds to junction 68 and to step 70 where the inquiry is made as to whether the page(s) have been scanned for all student(s) on the Assessment Batch Student List. If the query made at step 70 is answered in the affirmative, the system proceeds to step 72 and updates the Scan Received status of the Assessment Batch to All. The system then proceeds to step 74 and updates the Preliminary Evaluation status of the current Assessment Batch to Ready and then proceeds to step 76. If the determination at step 70 is answered in the negative, the system proceeds to step 78 and updates the Scan Received status of the Current Assessment Batch To Partial and proceeds to step 80 to update the Preliminary Evaluation Status of the Current Assessment Batch to Pending and proceeds to step 76.

At step 76, the enquiry is made as to whether the last Assessment Batch from the page(s) has been scanned in. If the enquiry at step 76 is answered in the negative, the system proceeds to step 82 and operates to Get a next Assessment Batch from page(s) scanned in and then proceeds to junction 68.

However, if the enquiry at step 76 is answered in the affirmative, the system proceeds to step 84 (see FIG. 48) where the system displays the list of Assessment Batch(es) scanned in with Pending Preliminary Evaluation status at the MFD DUI and prompts for selection. The system then proceeds to step 86 and enquires as to whether an Assessment Batch with Pending Preliminary Evaluation status has been selected. If the determination at step 86 is answered in the affirmative, the system proceeds to step 88 and displays on the MFD DUI the names of the students with a not-scanned status for the selected Assessment Batch. The system then proceeds to step 90.

However, if the enquiry at step 86 is answered in the negative, the system proceeds to step 92 and enquires as to whether a default time has passed. If the answer to the query at step 92 is affirmative, the system proceeds to junction 94. However, if the determination in step 92 is negative, the system proceeds to step 96 and enquires as to whether Manual Exit has been selected. If the enquiry at step 96 is answered in the affirmative, the system proceeds to junction 94. However, if the enquiry at step 96 is answered in the negative, the system proceeds to junction 98 and recycles to step 84. From junction 94, the system proceeds to step 100 and sends an email to the associated teachers for all Assessment Batch(es) scanned with Pending Preliminary Evaluation status. The names of the students with missing assessments are included and an appropriate link for further information or input from the associated teacher(s) is provided; and, the system then stops at step 102.

If the termination or query at step 90 is answered in the negative, the system proceeds to junction 104 and to junction 106 and to junction 98.

However, if the query at step 90 is answered in the affirmative, the system proceeds to step 108 and enquires as to whether the teacher/educator is authorized to request the evaluation. If the enquiry at step 108 is answered in the negative, the system proceeds to junction 104. However, if the query for authorization at step 108 is answered in the affirmative, the system proceeds to step 110 and updates the Preliminary Evaluation status of selected Assessment Batch to Ready and proceeds to junction 106.

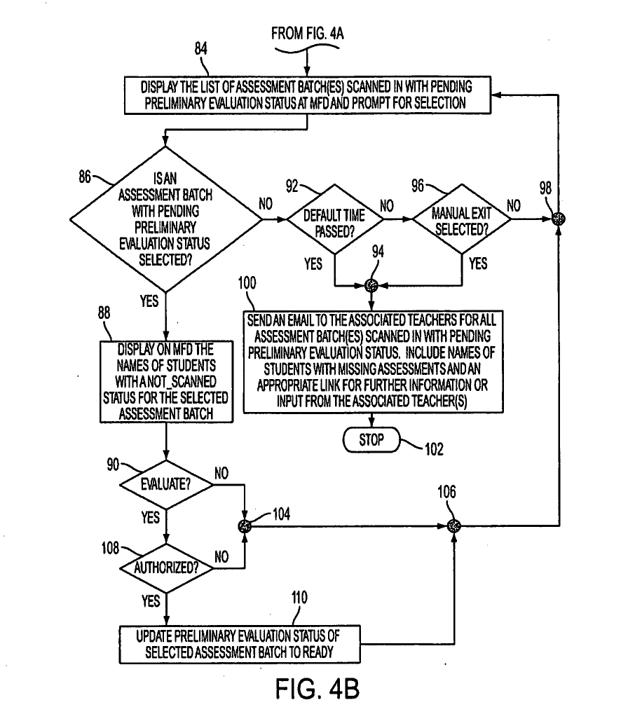

Referring to FIG. 5, the teacher/educator initiates a query for the evaluations at step 112 and the system proceeds to junction 114 and then to step 116 and enquires as to whether there are Assessment Batch(es) in the Data Warehouse/Repository with Preliminary Evaluation status of Ready. If the query at step 116 is answered in the negative, the system proceeds to stop at step 118. However, if the query at step 116 is answered in the affirmative, the system proceeds to step 120 and retrieves the image of the first scanned assessment page of the Assessment Batch and then proceeds to step 122 and automatically uses the registration fiducial marks to “register” the scanned image with the corresponding appropriate image of the original assessment layout. The system then proceeds to step 124 and automatically subtracts the scanned image from the corresponding stored original assessment layout image to “lift” the manually made marks for each image.

The system then proceeds to step 126 and automatically applies the rubric (associated with each item on the assessment) for each image of the “lifted” marks to tabulate results of the assessment, whereupon each assessment image mark is evaluated. In doing so, the system automatically decodes each mark using analysis of the shape of the mark, the color of the mark, or the location of the mark within a field, or any combination of the color, the shape and the location of the mark within a field, where a field is a specified region located within the image of the scanned and registered assessment page. The system then proceeds to 128 and, for each assessment item, automatically generates a rating to indicate the confidence level that the rubric was successfully applied to the item. The system then proceeds to step 130 and automatically stores the assessment evaluation results in the Data Warehouse/Repository and proceeds to step 132.

At step 132, the system enquires as to whether this is the last image of the Assessment Batch. If the determination at step 132 is answered in the negative, the system proceeds to step 134 and proceeds to get the image of the next scanned assessment and proceeds to return to step 120.

However, if the query at step 132 is answered in the affirmative, the system proceeds to step 136 and sends the teacher an email/notification that preliminary evaluation of the Assessment Batch is complete and provides a brief preliminary evaluation summary report and a link to the preliminary evaluation results to the Data Warehouse/Repository interface for the Assessment Batch. The system then proceeds to step 138 and updates the Preliminary Evaluation status of the Assessment Batch to Done in the Data Warehouse/Repository. The system has thus completed the evaluation phase of the method of the present disclosure.

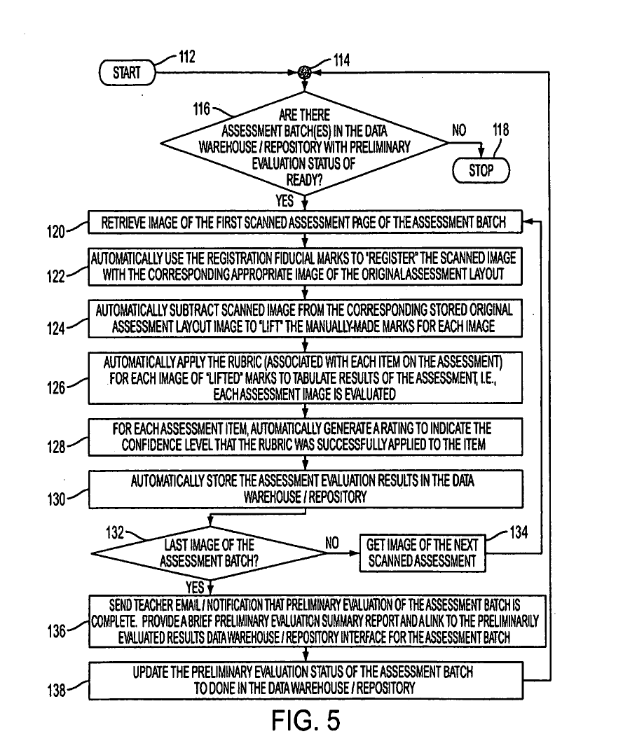

Referring to FIG. 6, the validation phase of the present method is begun by the teacher receiving an email from the system that preliminary evaluation of an Assessment Batch is complete and a link is provided to the Data Warehouse/Repository. The system then proceeds to step 142 where the teacher accesses the Validation Interface for the Assessment Batch in the Data Warehouse/Repository by selecting the link provided in the notification.

The teacher then provides the authentication information requested at step 144 and the system proceeds at step 146 to queue up the first evaluated assessment in the Assessment Batch. At step 148, the teacher views an image of the assessment with the manually made marks, the appropriate “key” information for each item (derived from the assessment rubric), the automatic evaluations for each item and color coded confidence levels for each item. At step 150, the teacher may perform a verification of the preliminary evaluation, and input corrections/updates/modifications as necessary to the preliminary evaluation; and, the system proceeds to step 152 and enquires as to whether annotations or metadata are to be added. If the enquiry at step 152 is answered by the teacher/educator in the negative, the system proceeds to step 154. However, if the enquiry at step 152 is answered in the affirmative, the teacher adds annotations/metadata to the assessment image at step 156 and the system proceeds to step 154.

At step 154, the system automatically updates the Data Warehouse/Repository with the corrected assessment data and any assessment image annotation/metadata. The system then proceeds to step 158 and updates the Validation Status of the assessment to Done in the Data Warehouse/Repository and proceeds to step 160.

At step 160, the system asks whether another assessment is to be viewed; and, if the answer to the query at step 160 is negative, the system proceeds to step 162 and updates the Validation Status of the Assessment Batch to Done in the Data Warehouse/Repository and proceeds to stop.

However, if the query at step 160 is answered in the affirmative, the system proceeds to step 164, queues up the next assessment and returns to step 148.

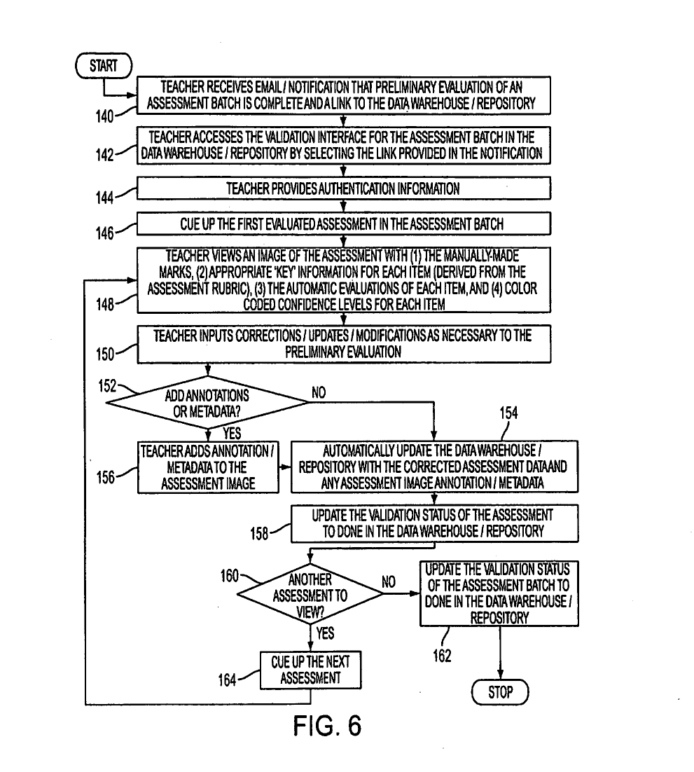

Referring to FIG. 7, the report phase of the method of the present disclosure is shown in block diagram wherein at step 166, the teacher requests a report for an Assessment Batch with a Validation Status of Done. The system proceeds to step 168 and enquires as to whether the teacher's request was at the MFD; and, if the answer to the query is negative, the system proceeds to step 170 and the teacher accesses the Data Warehouse/Repository remotely and the system requires at step 172 for the teacher to provide authentication and identification and proceeds to step 174 where the teacher selects the validated Assessment Batch. The system then enables the teacher to select at step 176 one of the known collection of predefined types of reports from a menu and proceeds to step 178 where the teacher provides any relevant information required by the report. The system then proceeds to step 180 and the report is displayed at the remote location with option to print and the system proceeds to step 182.

If the query at step 168 is answered in the affirmative, the teacher provides authentication information at step 184 and at step 186, the teacher selects the validated Assessment Batch at the MFD DUI. Next, the teacher selects at step 188 one of the known collection of predefined types of reports at the MFD DUI and at step 190, the teacher provides any relevant information required by the report and the system proceeds to step 192 and the report is printed at the MFD and the system proceeds to step 182.

At step 182, the query is made as to whether the report is to be stored in the Data Warehouse/Repository. If the query at step 182 is answered in the negative, the system stops. However, if the enquiry at step 182 is answered in the affirmative, the system proceeds to step 184 and stores the report and proceeds to stop.

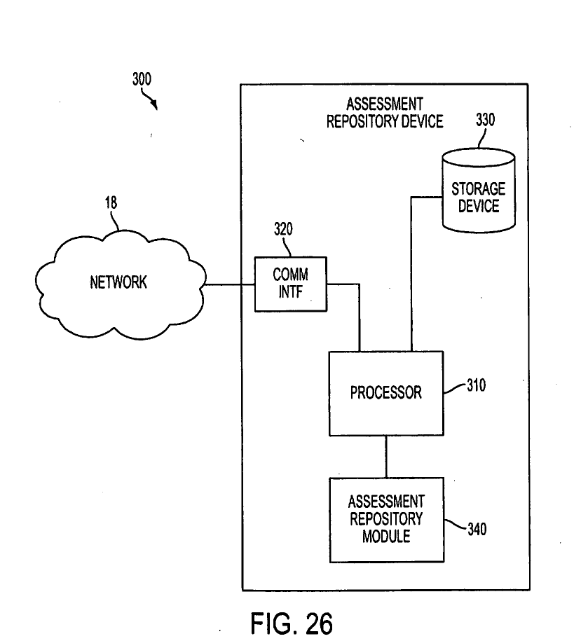

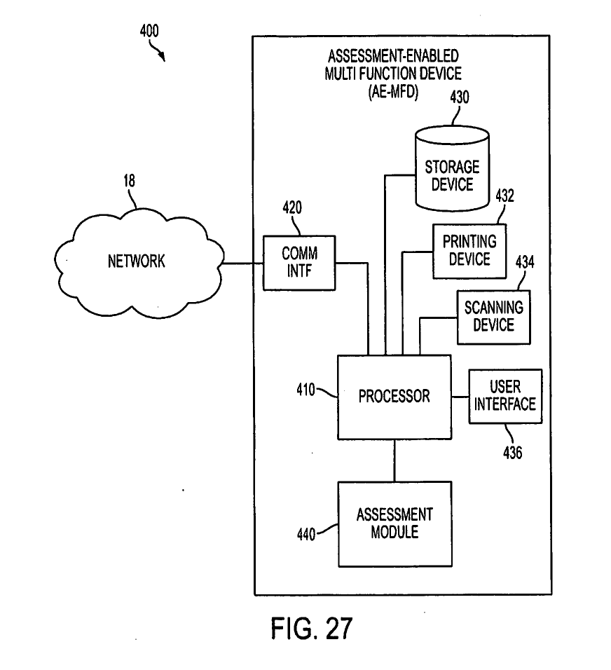

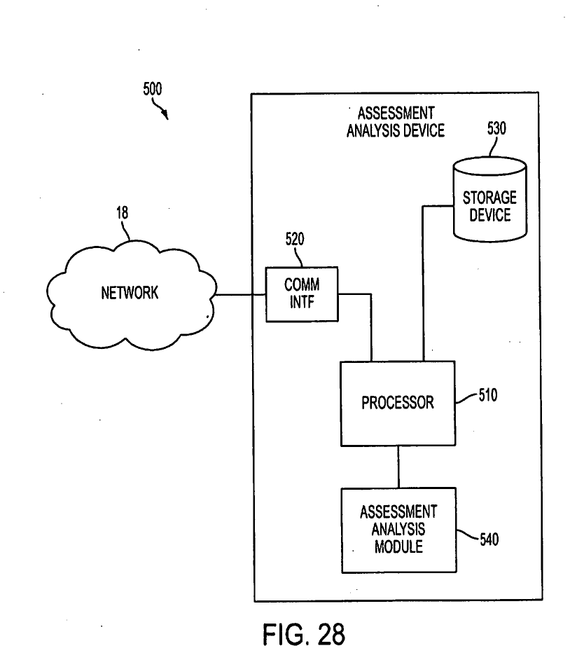

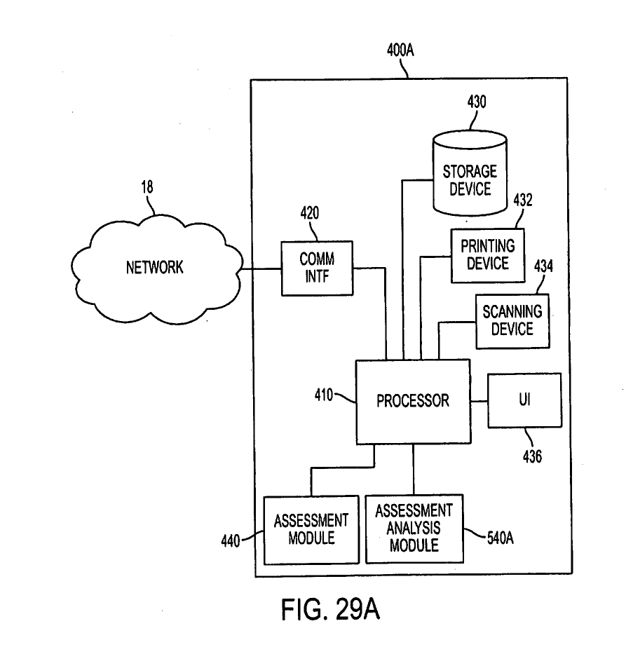

With reference now to FIGS. 25-31, an embodiment of an educational assessment system 200 in accordance with the present disclosure includes an assessment-enabled multi-function device 400, an assessment repository device 300, an assessment analysis device 500, and an assessment access device 600. The assessment-enabled multi-function device 400, assessment repository device 300, and assessment analysis device 500 are interconnected by a data network 18 as previously described herein.

The assessment-enabled multi-function device 400 includes in operable communication a processor 410, scanning assembly 434, a printing assembly 432, a storage device 430, a user interface 436, and a communication interface 420. Assessment-enabled multi-function device 400 further includes an assessment module 440 having at least one of software, firmware and hardware for performing a method of accessing EAS services as disclosed herein. In one embodiment, assessment module 440 includes a software program having a set of programmable instructions configured for execution by the at least one processor 410 of the multi-function device 400 for accessing EAS services. In embodiments, assessment module 440 includes executable instructions for at least one of selecting the EAS print service, permitting a user to choose assessment forms, permitting a user to choose an assessment class or part thereof (i.e., a group of students for whom assessments are to be printed), print a set of assessments, scan a set of assessments, communicate with an assessment repository device 300, and communicate with an assessment analysis device 500.

In embodiments, the assessment module 440 may include a set of application programming interfaces (APIs) implementing a modular application programming architecture, for example without limitation, the Extensible Interface Platform (EIP) developed by Xerox Corporation. Software instructions compliant with, for example, the EIP API and configured to implement the aforesaid assessment module functions may be dynamically downloaded to and/or executed by multi-function device 400. In embodiments the assessment module 440 may be a web-based application (e.g., a web service or “webapp”) executable by and/or executed on the multi-function device 400. The downloaded and/or executable software instructions implementing assessment module 400 may be pre-programmed into multi function device 400, or may be dynamically downloaded from, for example, an assessment repository device 300, assessment analysis device 500, EIP application server 14, or other network server on a local- or wide-area network. In embodiments, downloads are provided on a per-use basis and may incur access and/or download fees to the end user (i.e., the school/educator.)

The assessment repository device 300 includes in operable communication a processor 310, a storage device 330, and a communication interface 320. An assessment repository device 300 further includes an assessment repository module 340 having at least one of software, firmware and hardware for performing at least one of communicating with a multi-function device 400, communicating with an assessment analysis device 500, storing a scanned assessment, storing metadata relating to a scanned assessment, and maintaining at least one assessment database (not explicitly shown.)

The assessment analysis device 500 includes in operable communication a processor 510, a storage device 530, and a communication interface 520. An assessment repository device 500 further includes an assessment analysis module 540 having at least one of software, firmware and hardware for performing at least one of communicating with a multi-function device 400, communicating with an assessment repository device 300, retrieving a scanned image of an assessment, storing and/or retrieving a rubric, processing the scanned image to detect manually-made marks thereon, applying an associated assessment rubric to evaluate the assessment, and storing the assessment evaluation.

Assessment repository module 340 and/or assessment module 440 may also include a webserver 730 for presenting to a user/teacher an image of an assessment, including any manually-made marks thereon, presently corresponding answer key information, and for presenting to the user/teacher the preliminary assessment evaluation results and facilitating the review and modification thereof. In this manner, the user/teacher may input corrections to an assessment evaluation that may manifest from, for example without limitation, stray marks, incomplete or malformed marks, and/or manually-made marks that may have been misinterpreted by assessment module 440.

In embodiments, at least one of the assessment repository module 340, assessment module 440, and assessment analysis module 540 may include the capability to transmit an email message (not explicitly shown.) The email message may include information relating to the assessment evaluation results, summary information related to an assessment batch, and/or a hypertext link to an assessment review page, e.g., which may be formatted and transmitted to the user/teacher by a webserver 730, which may be included with assessment repository module 340, assessment module 440 as described hereinabove, or included within a standalone server (not explicitly shown).

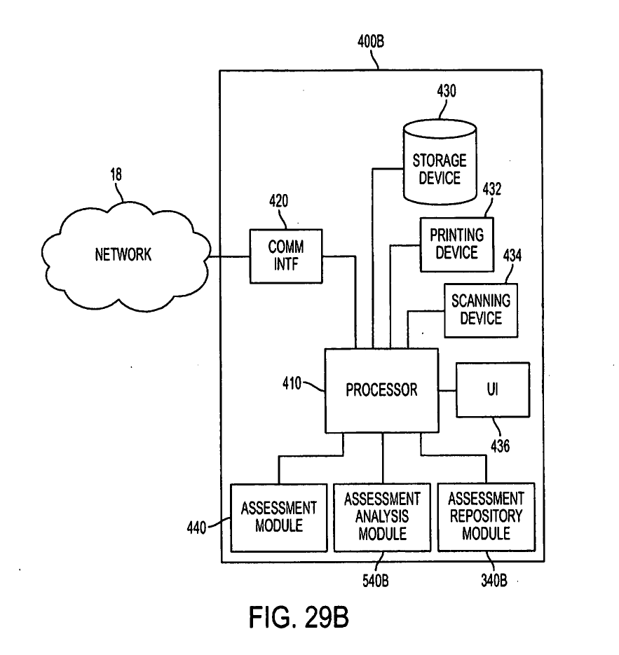

Referring now to FIG. 29A, embodiments of an Assessment-Enabled Multi Function Device (AE-MFD) in accordance with the present disclosure are presented wherein a multi function device 400A further includes an assessment analysis module 540A in operable communication with the processor 410. Assessment analysis module 540A includes at least one of software, firmware and hardware for performing at least one of communicating with an assessment module 400, assessment repository device 300, retrieving a scanned image of an assessment, storing and/or retrieving a rubric, processing the scanned image to detect manually-made marks thereon, applying an associated assessment rubric to evaluate the assessment, and storing the assessment evaluation. In FIG. 29B, an Assessment-Enabled Multi Function Device (AE-MFD) in accordance with the present disclosure is presented wherein a multi function device 400B further includes an assessment repository module 340B having at least one of software, firmware and hardware for performing at least one of communicating with an assessment module 400, and assessment analysis device 500 and/or assessment analysis module 540B, storing a scanned assessment, storing metadata relating to a scanned assessment, and maintaining at least one assessment database 720.

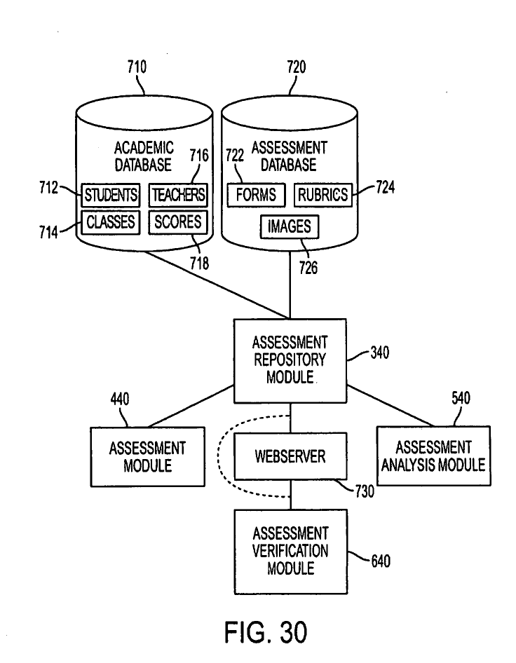

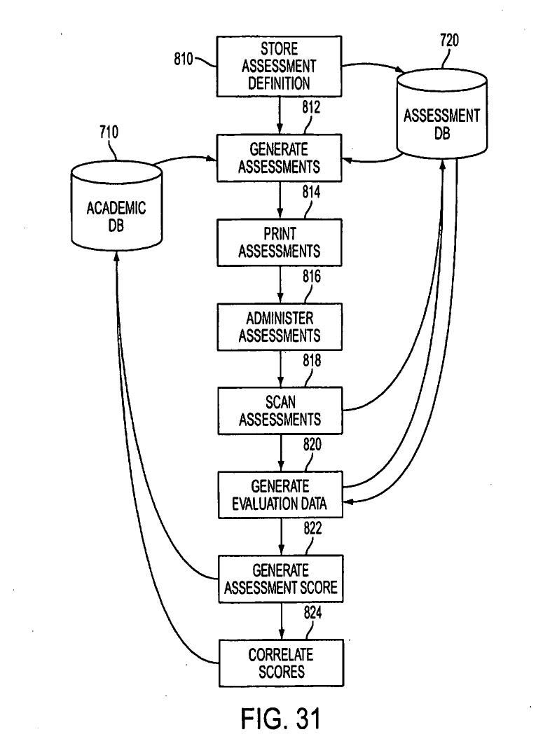

Turning to FIGS. 30-31, an academic database 710 includes a student data collection 712, class data collection 714, teacher data collection 716, and a scores data collection 718. An assessment database 720 includes a forms data collection 722 and a rubrics data collection 724. In embodiments, a data collection may be organized as a database table as will be familiar to the skilled artisan. The assessment repository module 340 is in operable communication with academic database 710 and assessment database 720, and may additionally be in operable communication with assessment module 440, assessment analysis module 540, and assessment access module 640. Assessment access module 640 may be in communication with assessment repository module 340 via webserver 730. In embodiments, assessment access module 640 includes a web browser.

In use, assessment definitions are stored in assessment database 720 at step 810. An assessment definition may include the physical layout of the assessment, which may be stored in a forms data collection 722, and an associated rubric (e.g., answer key), which may be stored in a rubrics data collection 724. An images data collection 726 for storing scanned images of administered assessments, and optionally or alternatively metadata associated therewith, may be included in assessment database 720. Images data collection 726 may additionally or alternatively be included in storage device 530 of assessment analysis device 500. In the step 812, assessment(s) are generated using assessment definitions stored in assessment database 720 and using at least one of student, class, and teachers database, such that each assessment thus generated uniquely corresponds to an individual student. The assessment(s) are then printed in the step 814, at the multi-function device 400, or, optionally or alternatively, at a standalone printer, fax, or other rendering device capable of rendering pages. In embodiments, assessments may be printed to a Portable Document Format (PDF) file.

In embodiments, printed assessments may include a machine readable identifier, such as without limitation a barcode, which may include at least one of the student's name, student identification number, classroom identifier, teacher identifier, assessment identified, date, and the like.

The printed assessment sheets are administered to students in the step 816 wherein student response(s) are recorded on the sheets, and in the step 818 the completed assessments are scanned and stored in image data collection 726, optionally, scanned assessment data is stored in connection with associated metadata.

In the step 820 assessment analysis module 540 evaluates the scanned assessment data. Assessment analysis module 540 may use an identifier from the assessment sheet(s), if available, such as the barcoded machine-readable identifier or human readable identifier (i.e., pre-printed or handwritten textual identifiers) to determine the student, class, teacher, and/or assessment ID corresponding to the assessment. Analysis module 540 uses rubric data corresponding to the assessment(s) to generate evaluation data which in the step 822 is used to generate an assessment score for each scanned assessment. In the step 822, the assessment score is stored in academic database 710. The academic database may contain granular data, e.g., data corresponding to every test, for every student, in every grade. Granular data may extend to historical data (e.g., data from every preceding year) and/or geographic data (e.g., data from various school districts, counties, and so forth.) The step 824 may be optionally executed wherein individual assessment responses are correlated to identify a student group(s) having a common response type. For example without limitation, responses may be grouped to identify students who provided similarly incorrect assessment responses (to identify groups of students who may require special help in a particular subject area). As another example, students may be grouped according to those who responded in a manner consistent with a learning disability (e.g., consistent reversed or inverted responses may indicate dyslexia.)

The present disclosure thus describes an automatic evaluation assessment service which employs image analysis to scanned assessments marked by either a teacher or a student and automatically evaluates the assessments employing image analysis according to established rubrics and provides reports which the teacher may print out and simultaneously updates a repository containing the assessments and personal information as to the students. The method described employs generating an Assessment Batch which includes at least one student and one assessment and a student list of selected students associated with the assessment which may include the entire class. Thus, when the assessments are marked and scanned in, evaluated and stored in the repository, the teacher/educator may validate the assessment evaluation and then subsequently retrieve this information after a period of time in which the Data Warehouse/Repository has been updated for assessments over a time period.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims. The claims can encompass embodiments in hardware, software, or a combination thereof.

What is claimed is:

1. A method for educational assessment analysis, comprising:
A. storing educational assessment definitions in an assessment repository device, wherein each assessment definition includes a scoring rubric and datum representative of an unadministered assessment;
B. receiving datum representative of an administered assessment, wherein the administered assessment includes a free form mark;
C. comparing datum representative of the unadministered assessment to datum representative of the administered assessment to identify differences therebetween;
D. applying the rubric to the identified differences to establish at least one educational assessment score derived from the free form mark; and
E. storing the educational assessment score in the assessment repository device.

2. The method in accordance with claim 1, further comprising deriving an identifier from the identified differences.

3. The method in accordance with claim 2, wherein the identifier is selected from the group consisting of a student identifier, a teacher identifier, a class identifier, an assessment identifier, and a date identifier.

4. The method in accordance with claim 1, wherein the said D. includes assigning a confidence level to the said educational assessment score.

5. The method in accordance with claim 4, wherein the said E. includes storing said confidence level in the assessment repository device.

6. The method in accordance with claim 1, further comprising correlating a plurality of educational assessment scores to identify at least one student group wherein the student group comprises one response type.

7. The method in accordance with claim 6, wherein data representative of the identified correlated student groups is stored in the assessment repository device.

8. An educational assessment analysis system, comprising:
an educational assessment analysis module;
an assessment repository device operatively associated with said educational assessment analysis module, wherein said educational assessment analysis module is configured to:
identify a difference between an unadministered educational assessment and an administered assessment, the administered assessment including at least one student response,
receive a rubric from the assessment repository device, and
apply the rubric to said identified difference between the unadministered educational assessment and the administered assessment to obtain a set of granular data representative of the at least one student response.

10. The educational assessment analysis system of claim 9, wherein the educational assessment analysis module is further configured to store the educational assessment score on the assessment repository device.

11. The educational assessment analysis system of claim 9, wherein the educational assessment analysis module is further configured to assign a confidence level to the educational score.

12. The educational assessment analysis system of claim 11, wherein the educational assessment analysis module is further configured to store the confidence level on the assessment repository device.

13. The educational assessment analysis system of claim 8, said educational assessment analysis module further configured to derive an identifier from an administered assessment.

14. The educational assessment analysis system of claim 13, wherein said derived identifier is selected from the group consisting of a student identifier, a teacher identifier, a class identifier, an assessment identifier, and a date identifier.

15. The educational assessment analysis system of claim 8, wherein the educational assessment analysis module is further configured send a notification to a user, wherein the notification includes a link to a representation of an educational assessment score.
